(19) United States
(12) Patent Application Publication
(10) Pub. No.: US 2026/0031460 A1
(43) Pub. Date: Jan. 29, 2026

(54) METHOD OF MANUFACTURING BATTERY PACK

(71) Applicant: TOYOTA JIDOSHA KABUSHIKI KAISHA, Toyota-shi (JP)

(72) Inventor: Osamu Yamashita, Toyota-shi (JP)

(73) Assignee: TOYOTA JIDOSHA KABUSHIKI KAISHA, Toyota-shi (JP)

(21) Appl. No.: 19/096,923

(22) Filed: Apr. 1, 2025

(30) Foreign Application Priority Data
Jul. 23, 2024 (JP) 2024-117904

(51) Int. Cl. H01M 50/244; H01M 50/207

(52) U.S. Cl. CPC H01M 50/244; H01M 50/207

(57) ABSTRACT

A method of manufacturing a battery pack including a molding step of molding a case that accommodates a battery, in which the molding step includes a step of bringing a bottom portion of a lower case into close contact with a jig to cause the bottom portion to have a flat plate shape and a step of bonding a cooler to a lower surface of the lower case in a state where the bottom portion of the lower case is brought into close contact with the jig.

### CROSS-REFERENCE TO RELATED APPLICATION

This application claims priority to Japanese Patent Application No. 2024-117904 filed on Jul. 23, 2024. The disclosure of the above-identified application, including the specification, drawings, and claims, is incorporated by reference herein in its entirety.

### BACKGROUND

### 1. Technical Field

The present disclosure relates to a method of manufacturing a battery pack.

### 2. Description of Related Art

Japanese Unexamined Patent Application Publication No. 2023-046659 (JP 2023-046659 A) discloses a battery pack including a case that accommodates a battery and a cooler that cools the battery. In the configuration described in JP 2023-046659 A, the cooler having a plate shape is disposed outside the case and is bonded to a lower surface of the case.

### SUMMARY

By the way, the case of the battery pack may be molded by press processing. However, in a case where the case is large, it is difficult to press-process a bottom portion of the case with high flatness. In a case where an adhesive is applied to the bottom portion of the case having uneven portions, the adhesive that merely fills the uneven portions is applied, and thus a layer of the adhesive becomes thick. Therefore, in a structure in which a cooler is bonded to a lower surface of a case as in the configuration described in JP 2023-046659 A, there are areas where the adhesive is thick, resulting in an increase in thermal resistance and a decrease in cooling performance.

The present disclosure provides a method of manufacturing a battery pack in which a plate-shaped member can be joined to a bottom portion of a case in a state of good flatness.

An aspect of the disclosure relates to a method of manufacturing a battery pack including a molding step of molding a case that accommodates a battery. The molding step includes a first step of bringing a bottom portion of the case into close contact with a jig to cause the bottom portion to have a flat plate shape, and a second step of joining a plate-shaped member to a lower surface of the case in a state where the bottom portion of the case is brought into close contact with the jig.

According to the aspect of the disclosure, the plate-shaped member can be joined to the bottom portion of the case in a state of good flatness.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for describing a method of manufacturing a battery pack according to an embodiment;

FIG. 2 is a diagram for describing a method of manufacturing a battery pack in a case where vacuum adsorption is used; and

FIG. 3 is a diagram for describing a method of manufacturing a battery pack in a case where a plate-shaped member is a protection member.

### DETAILED DESCRIPTION OF EMBODIMENTS

Hereinafter, a method of manufacturing a battery pack according to an embodiment of the disclosure will be specifically described. An aspect of the disclosure is not limited to the embodiments described below.

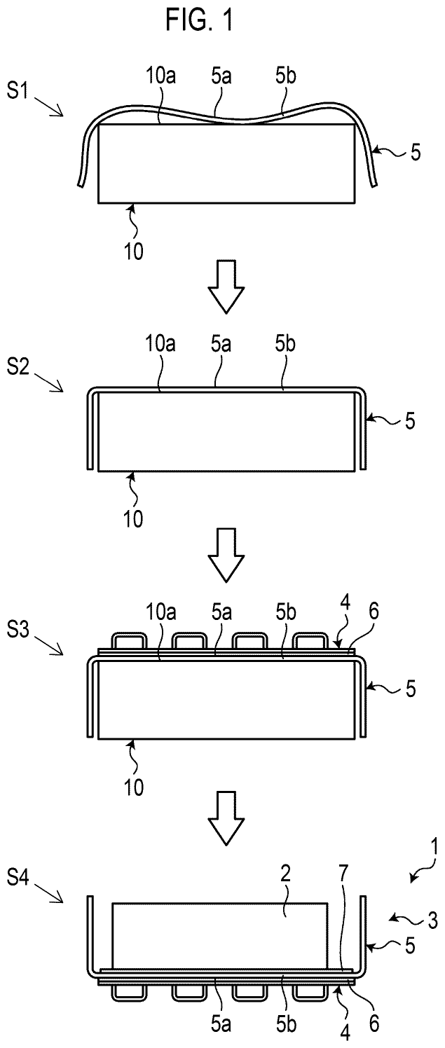

FIG. 1 is a diagram for describing a method of manufacturing a battery pack according to an embodiment. The battery pack 1 includes a battery 2, a case 3 that accommodates the battery 2, and a cooler 4 that cools the battery 2. The case 3 includes an upper case and a lower case 5. The cooler 4 is provided on the outside of the case 3 and is joined to a lower surface 5a of the lower case 5. A lower surface 5a of the lower case 5 is a lower surface of the case 3. Inside the cooler 4, a flow path through which a coolant that cools the battery cell flows is provided. The battery cell is cooled by a coolant flowing through the inside of the cooler 4. A cross section of the battery pack 1 is shown in FIG. 1.

The method of manufacturing the battery pack 1 includes a molding step (steps S1 to S3) of molding the case 3 and an installation step (step S4) of installing the battery 2 in the case 3 after the molding.

The molding step includes a step (from step S1 to step S2) of using the jig 10 to cause the bottom portion 5b of the lower case 5 to have a flat plate shape, and a step (step S3) of joining the cooler 4 to the lower surface 5a of the lower case 5.

Specifically, first, the lower case 5 after the press working is placed on the jig 10 (step S1). The case 3 is a case made of metal. For example, the lower case 5 is made of iron. In the large case 3, the bottom portion 5b of the lower case 5 is also increased in size, and thus the flatness of the bottom portion 5b may be poor in the lower case 5 after the press working. The bottom portion 5b of the lower case 5 is warped (including an uneven shape) after the press working. The jig 10 is formed in the same shape as the press die. The jig 10 includes an electromagnet and has a flat-shaped adsorption surface 10a. For example, the jig 10 is a jig with an electromagnet. The electromagnet of the jig 10 is turned on by energization, and it is possible to generate magnetic force from the electromagnet. In step S1, the electromagnet of the jig 10 is turned off, and the lower surface 5a of the lower case 5 is directed upward to place the lower case 5 on the jig 10. In a state where the lower case 5 is placed on the jig 10, the inner surface of the bottom portion 5b and the adsorption surface 10a face each other. A cross section of the jig 10 is shown in FIG. 1.

Next, the bottom portion 5b of the lower case 5 is brought into close contact with the jig 10 (step S2). In step S2, the electromagnet included in the jig 10 is energized to generate magnetic force, and the bottom portion 5b of the lower case 5 is adsorbed to the adsorption surface 10a of the jig 10 by the magnetic force generated by the electromagnet. The jig 10 including the electromagnet can generate a magnetic force by energization such that the bottom portion 5b of the lower case 5 is adsorbed to the adsorption surface 10a. In step S2, the electromagnet included in the jig 10 is turned on, and the bottom portion 5b of the lower case 5 is in a state of being magnetically adsorbed to the jig 10. The state in which the bottom portion 5b is magnetically adsorbed to the jig 10 is a state in which the flatness of the bottom portion 5b is temporarily improved. That is, in a case where the electromagnet is returned to the turned-off from the turned-on state in step S2, the shape of the bottom portion 5b returns from the flat plate shape shown in step S2 to the uneven shape shown in step S1.

Next, the cooler 4 is joined to the lower surface 5a of the lower case 5 in a state where the bottom portion 5b of the lower case 5 is in close contact with the jig 10 (step S3). In step S3, the cooler 4 is bonded to the lower surface 5a of the lower case 5 via the adhesive 6 in a state where the bottom portion 5b of the lower case 5 is magnetically adsorbed to the jig 10 (a state in which the flatness of the bottom portion 5b is temporarily improved). The adhesive 6 is a joining member for joining the plate-shaped member to the lower surface 5a of the lower case 5. For example, the adhesive 6 is formed of a thermally conductive adhesive. The cooler 4 is a plate-shaped member joined to a lower surface 5a of the lower case 5. The cooler 4 includes a flat plate portion facing the lower surface 5a of the lower case 5.

For example, in step S3, the adhesive 6 is applied to the lower surface 5a of the lower case 5, and the flat plate portion of the cooler 4 is bonded to the lower surface 5a from above the adhesive 6. After the bonding, the bottom portion 5b of the lower case 5, the adhesive 6, and the cooler 4 are laminated to form a sandwich panel structure. Therefore, the bottom portion 5b side of the lower case 5 is high in rigidity. As a result, the flatness of the bottom portion 5b is not deteriorated even when the state in which the bottom portion 5b is brought into close contact with the jig 10 is released. That is, even when the close contact with the jig 10 is released, the shape of the bottom portion 5b does not return to the uneven shape shown in step S1, and the flatness of the bottom portion 5b can be maintained in a good state. As described above, step S3 includes a step of stopping the energization after the cooler 4 is bonded and releasing the state in which the bottom portion 5b is brought into close contact with the jig 10 by placing the jig 10 in a state where the electromagnet is turned off. In a case where the electromagnet is turned off before the cooler 4 is bonded to the lower surface 5a through the adhesive 6, the shape of the bottom portion 5b returns to the flat plate shape shown in step S1 from the uneven shape shown in step S2. In step S3 before the release, the cooler 4 is bonded to the lower surface 5a with the adhesive 6.

In addition, in step S3, the adhesive 6 is applied to the lower surface 5a in a temporarily good flatness state by the magnetic adsorption, so that the adhesive 6 is thin and the cooling performance is high, and the amount of the adhesive 6 is small and the cost is low. In a case where the adhesive 6 is applied to the lower surface 5a in a state where the shape of the bottom portion 5b is the uneven shape shown in step S1, the adhesive 6 that merely fills the unevenness of the lower surface 5a is applied. In this case, since there is a portion where the adhesive 6 is thick, the thermal resistance is increased, the cooling performance is deteriorated, and a large amount of the adhesive 6 is required, which increases the cost.

Then, the battery 2 is installed in the lower case 5 (step S4). In step S4, the battery cell of the battery 2 is bonded to the inner surface of the bottom portion 5b of the lower case 5 through the adhesive 7. The adhesive 7 is formed of a thermally conductive adhesive. For example, an adhesive 7 is applied to the inner surface of the bottom portion 5b of the lower case 5, and the lower surface of the battery cell is bonded to the inner surface of the bottom portion 5b from above the adhesive 7. In step S4, since the flatness of the bottom portion 5b is maintained in a good state by the sandwich panel structure, the adhesive 7 is thinly applied to the bottom portion 5b in the good state, so that the adhesive 7 is thin and the cooling performance is improved, and the amount of the adhesive 7 is reduced to reduce the cost. In a case where the adhesive 7 is applied to the inner surface of the bottom portion 5b in a state where the shape of the bottom portion 5b is the uneven shape shown in step S1, the adhesive 7 that merely fills the unevenness of the inner surface of the bottom portion 5b is applied. In this case, since there is a portion where the adhesive 7 is thick, the thermal resistance is increased, the cooling performance is deteriorated, and a large amount of the adhesive 7 is required, which increases the cost.

As described above, according to the embodiment, the sandwich panel structure is formed by the bottom portion 5b, the adhesive 6, and the cooler 4 in a state where the flatness of the bottom portion 5b of the lower case 5 is temporarily improved by magnetic adsorption. As a result, the flatness of the bottom portion 5b can be maintained in a good state even when the close contact with the jig 10 is released.

Although a method of magnetically adsorbing the jig 10 has been described, the method of manufacturing the battery pack 1 is not limited thereto. The method of bringing the bottom portion 5b into close contact with the jig is not limited to magnetic adsorption, and may be vacuum adsorption.

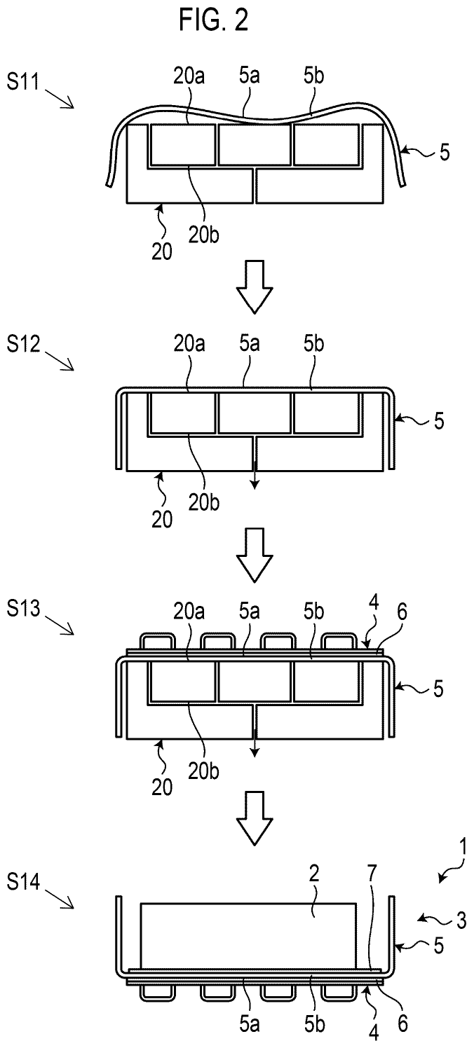

As shown in FIG. 2, the method of manufacturing the battery pack 1 when using vacuum adsorption includes a step of bringing the lower case 5 into close contact with the jig 20. The jig 20 is formed in the same shape as the press die. The jig 20 has a flat-shaped adsorption surface 20a and a vacuum drawing circuit 20b. For example, the vacuum drawing circuit 20b is constituted by a pipe. The method of manufacturing the battery pack 1 using the jig 20 includes a molding step (steps S11 to S13) of molding the case 3 and an installation step (step S14) of installing the battery 2 in the case 3 after the molding. The molding step includes a step (steps S11 to S12) of using the jig 20 to cause the bottom portion 5b of the lower case 5 to have a flat plate shape and a step (step S13) of joining the cooler 4 to the lower surface 5a of the lower case 5. Since step S14 is the same as step S4, the description thereof will be omitted. In addition, a cross section of the jig 20 is shown in FIG. 2.

First, the lower case 5 after the press working is placed on the jig 20 (step S11). When the vacuum drawing from the vacuum drawing circuit 20b is turned on, the jig 20 can be vacuum adsorbed. In step S11, the vacuum drawing of the jig 20 is turned off, the lower surface 5a of the lower case 5 faces upward, and the lower case 5 is placed on the jig 20.

Next, the bottom portion 5b of the lower case 5 is brought into close contact with the jig 20 (step S12). In step S12, the vacuum drawing of the jig 20 is turned on, and the bottom portion 5b of the lower case 5 is adsorbed to the adsorption surface 20a of the jig 20 by vacuum adsorption. The state in which the bottom portion 5b is vacuum adsorbed to the jig 20 is a state in which the flatness of the bottom portion 5b is temporarily improved. In a case where the vacuum drawing is returned to turned-off state from the turned-on state in step S12, the shape of the bottom portion 5b returns from the flat plate shape shown in step S12 to the uneven shape shown in step S11.

Next, the cooler 4 is joined to the lower surface 5a of the lower case 5 in a state where the bottom portion 5b of the lower case 5 is brought into close contact with the jig 20 (step S13). In step S13, the cooler 4 is bonded to the lower surface 5a of the lower case 5 via the adhesive 6 in a state where the bottom portion 5b of the lower case 5 is vacuum adsorbed to the jig 20 (a state in which the flatness of the bottom portion 5b is temporarily improved).

As described above, in the method of manufacturing the battery pack 1 using the vacuum adsorption as shown in FIG. 2, the same effects as in the method of manufacturing the battery pack 1 using the magnetic adsorption can be obtained.

In addition, the plate-shaped member bonded to the lower surface 5a of the lower case 5 is not limited to the cooler 4. The plate-shaped member is not limited to the cooler 4, and may be a cover that protects the case 3.

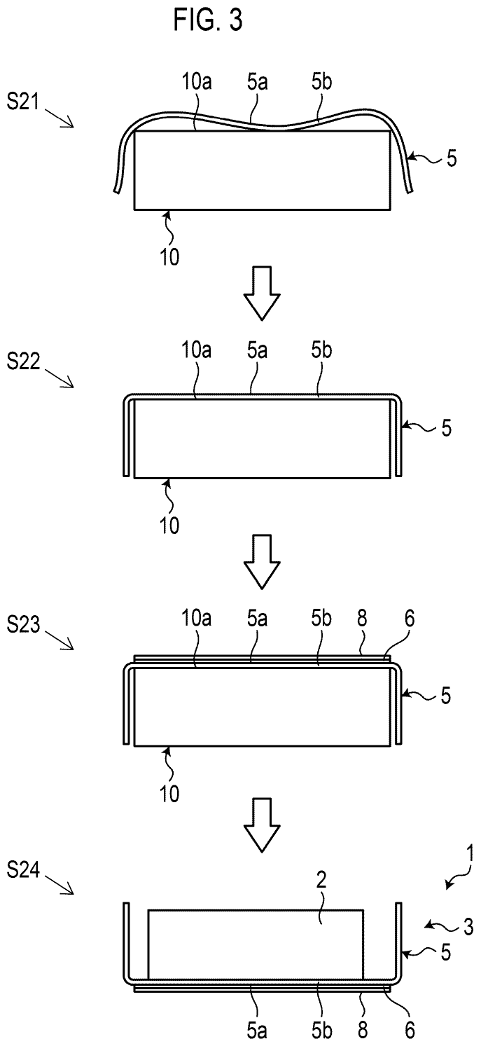

As shown in FIG. 3, the method of manufacturing the battery pack 1 in a case where the plate-shaped member is the protection member includes a step of bonding the shear panel 8 to the lower surface 5a of the lower case 5. The battery pack 1 has a structure in which the shear panel 8 is bonded to a lower surface 5a of the lower case 5. The shear panel 8 is a protection member that protects the case 3, and is a plate-shape protection cover that covers the lower surface 5a of the lower case 5. The method of manufacturing the battery pack 1 including the shear panel 8 includes a molding step (steps S21 to S23) of molding the case 3 and an installation step (step S24) of installing the battery 2 in the case 3 after the molding. The molding step includes a step (from step S21 to step S22) of using the jig 10 to cause the bottom portion 5b of the lower case 5 to have a flat plate shape and a step (step S23) of joining the shear panel 8 to the lower surface 5a of the lower case 5. Since steps S21 and S22 are the same as steps S1 and S2, the description thereof will be omitted. In addition, a cross section of the battery pack 1 is shown in FIG. 3.

In step S23, the shear panel 8 is joined to the lower surface 5a of the lower case 5 in a state where the bottom portion 5b of the lower case 5 is brought into close contact with the jig 10. The shear panel 8 is bonded to the lower surface 5a via the adhesive 6 in a state where the bottom portion 5b is magnetically adsorbed to the jig 10. The shear panel 8 includes a flat plate portion facing the lower surface 5a of the lower case 5. After the bonding, the bottom portion 5b of the lower case 5, the adhesive 6, and the shear panel 8 are laminated to form a sandwich panel structure, so that the bottom portion 5b side of the lower case 5 is made to have high rigidity. As a result, the flatness of the bottom portion 5b is not deteriorated even when the state in which the bottom portion 5b is brought into close contact with the jig 10 is released. Step S23 includes a step of stopping the energization after the cooler 4 is bonded and releasing the state in which the bottom portion 5b is brought into close contact with the jig 10 by placing the jig 10 in a state where the electromagnet is turned off.

Then, the battery 2 is installed in the lower case 5 (step S24). In step S24, the battery cells of the battery 2 are placed on the bottom portion 5b of the lower case 5. Since the sandwich panel structure maintains the flatness of the bottom portion 5b in a good state, the battery 2 is accommodated in the case 3. In a case where the battery 2 is placed in the case 3 in a state where the shape of the bottom portion 5b is the uneven shape shown in step S21, the flatness of the bottom portion 5b is poor, and the battery 2 may not be accommodated in the case 3. In this case, even when the flatness of the bottom portion 5b is poor, the case 3 has to be made large such that the battery 2 can be accommodated. That is, the energy density of the battery pack 1 is reduced.

As described above, with the method of manufacturing the battery pack 1 having the shear panel 8 as shown in FIG. 3, it is possible to avoid the reduction in energy density of the battery pack 1.

In addition, a method of joining the cooler 4 or the shear panel 8 to the lower surface 5a of the lower case 5 is not limited to bonding. The method of joining the plate-shaped members may be bonding, welding, friction stir welding, or mechanical fastening.

The battery 2 may be a battery module in which a plurality of battery cells is combined, or may be a plurality of battery cells in an unmodularized state. That is, the battery pack 1 may be a battery module as the battery 2 accommodated in the case 3, or may be a plurality of battery cells as the battery 2 directly accommodated in the case 3.

What is claimed is:

1. A method of manufacturing a battery pack, the method comprising a molding step of molding a case that accommodates a battery, wherein the molding step includes
a first step of bringing a bottom portion of the case into close contact with a jig to cause the bottom portion to have a flat plate shape, and
a second step of joining a plate-shaped member to a lower surface of the case in a state where the bottom portion of the case is brought into close contact with the jig.

2. The method according to claim 1, wherein the second step includes a step of joining a cooling member or a protection member as the plate-shaped member to the lower surface of the case.

3. The method according to claim 2, wherein the first step includes a step of generating a magnetic force by energizing an electromagnet included in the jig to cause the bottom portion of the case made of metal to be adsorbed onto an adsorption surface of the jig by the magnetic force generated by the electromagnet.

4. The method according to claim 2, wherein the first step includes a step of performing vacuum drawing from a vacuum drawing circuit provided in the jig to cause the bottom portion of the case to be adsorbed onto an adsorption surface of the jig by the vacuum drawing from the vacuum drawing circuit.

5. The method according to claim 3, wherein the second step includes a step of bonding the plate-shaped member to the lower surface of the case via an adhesive as the step of joining the plate-shaped member to the lower surface of the case.

6. The method according to claim 4, wherein the second step includes a step of bonding the plate-shaped member to the lower surface of the case via an adhesive as the step of joining the plate-shaped member to the lower surface of the case.
